(19) United States
(12) Patent Application Publication
(10) Pub. No.: US 2016/0334311 A1
(43) Pub. Date: Nov. 17, 2016

(54) CUMULATIVE OXO-ANION SAMPLER SYSTEMS AND METHODS

(71) Applicants: Paul K. Westerhoff, Scottsdale, AZ (US); Kiril D. Hristovski, Gilbert, AZ (US)

(72) Inventors: Paul K. Westerhoff, Scottsdale, AZ (US); Kiril D. Hristovski, Gilbert, AZ (US)

(21) Appl. No.: 15/152,016

(22) Filed: May 11, 2016

Related U.S. Application Data
(60) Provisional application No. 62/161,670, filed on May 14, 2015.

(51) Int. Cl. G01N 1/38; G01N 1/14; G01N 1/40

(52) U.S. Cl. CPC G01N 1/38; G01N 1/405; G01N 1/14

(57) ABSTRACT

The present disclosure provides systems and methods for measuring a water contaminant. In an exemplary embodiment the system comprises an intake configured to be in fluid communication with a water source of interest, a cumulative flow meter configured to measure the amount of water passing through the cumulative sampler system, and a sampler cell configured to receive water from the intake, the sampler cell comprising a media configured to adsorb the water contaminant.

### CROSS REFERENCE TO RELATED APPLICATIONS

This application claims priority to, and the benefit of, U.S. provisional patent application No. 62/161,670 filed on May 14, 2015 and entitled “CUMULATIVE OXO-ANION SAMPLER SYSTEMS AND METHODS,” which is incorporated herein by reference in its entirety.

### FEDERALLY SPONSORED RESEARCH OR DEVELOPMENT

This invention was made with government support under grant number RD835175 awarded by the U.S. Environmental Protection Agency's STAR program. The Government has certain rights in the invention.

### TECHNICAL FIELD

The present disclosure relates to water quality measurement, and specifically to systems and methods for determining levels of oxo-anions in drinking water.

### BACKGROUND

Water contaminants, for example oxo-anions such as hexavalent chromium, arsenate, selenate, and nitrate, pose human health and ecosystem risks. Additionally, determining the levels of these materials in a particular water source can be difficult. Typically, water sources are tested by grab sampling at extended intervals, and therefore sampling accuracy may be affected by temporal variability in water contaminant concentrations. Accordingly, improved systems and methods for determining levels of water contaminants are desirable.

### SUMMARY

In various embodiments, the present disclosure provides a cumulative sampler system for measuring a water contaminant, the system comprising an intake configured to be in fluid communication with a water source of interest, a cumulative flow meter configured to measure the amount of water passing through the cumulative sampler system, and a sampler cell configured to receive water from the intake, the sampler cell comprising a media configured to adsorb the water contaminant. In various embodiments, the cumulative sample system further comprises a pump coupled to the intake, the pump configured to draw water from the water source of interest through the intake. In various embodiments, the cumulative sample system further comprises a first valve disposed between the cumulative flow meter and the sampler cell, and a second valve disposed between the sampler cell and a discharge port of the cumulative sampler system.

In various embodiments, the sampler cell is removable from the cumulative sampler system. In various embodiments, the media comprises at least one of a strong base anion exchange resin or a weak base anion exchange resin. In various embodiments, the water contaminant comprises at least one of chromium (VI), arsenic, or selenium.

In various embodiments, the present disclosure provides a method for measuring a water contaminant, the method comprising passing, through a sampler cell configured to adsorb the water contaminant, a volume of water containing the water contaminant, extracting, from the sampler cell, a mass balance of the water contaminant, and comparing the mass balance to the volume of water to determine an average concentration of the water contaminant. In various embodiments, the method further comprises passing, through a cumulative flow meter, the volume of water.

In various embodiments, the passing through the sampler cell comprises a flowrate of about 15 bed volumes per hour. In various embodiments, the water contaminant comprises at least one of chromium (VI), arsenic, or selenium. In various embodiments, the extracting comprises passing, through the sampler cell, an eluant configured to desorb the water contaminant, collecting an eluate comprising the water contaminant, and determining the mass balance of the water contaminant. In various embodiments, the extracting further comprises at least one of filtering the eluate or diluting the eluate. In various embodiments, the extracting comprises digesting a media of the sampler cell and determining the mass balance of the water contaminant.

In various embodiments, the present disclosure provides a method for measuring a water contaminant, the method comprising passing, through a cumulative sampler system a volume of water, the cumulative sample system comprising a pump coupled to an intake, the pump configured to draw water from a water source of interest through the intake, a cumulative flow meter configured to measure the amount of water passing through the cumulative sampler system, and a sampler cell configured to receive water from the pump. In various embodiments, the method further comprises extracting, from the sampler cell, a mass balance of the water contaminant, and comparing the mass balance to the volume of water to determine an average concentration of the water contaminant.

In various embodiments, the water contaminant comprises at least one of chromium (VI), arsenic, or selenium. In various embodiments, the sampler cell comprises a media configured to adsorb the water contaminant. In various embodiments, the method further comprises passing, through the cumulative flow meter, the volume of water. In various embodiments, the extracting comprises passing, through the sampler cell, an eluant configured to desorb the water contaminant, collecting an eluate comprising the water contaminant, and determining the mass balance of the water contaminant. In various embodiments, the extracting further comprises at least one of filtering the eluate or diluting the eluate. In various embodiments, the extracting comprises digesting the media and determining the mass balance of the water contaminant.

The contents of this summary section are provided only as a simplified introduction to the disclosure, and are not intended to be used to limit the scope of the appended claims.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain the principles of the disclosure.

FIG. 1 illustrates a schematic diagram of an exemplary cumulative sampling system in accordance with various embodiments;

FIGS. 2A and 2B illustrate methods for using an exemplary cumulative sampling system in accordance with various embodiments;

FIG. 3 illustrates a method for using an exemplary cumulative sampling system in accordance with various embodiments; and

FIGS. 4A and 4B illustrate partial methods for using an exemplary cumulative sampling system in accordance with various embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various logical, chemical, and mechanical changes may be made in the function and arrangement of the elements described in these embodiments without departing from the spirit and scope of the present disclosure.

Concentrations of certain oxo-anions, including hexavalent chromium Cr(VI), arsenate, selenate, nitrate, and others, in potable water are of concern to many communities around the world. However, typically little is known about hourly or daily variations in concentrations of oxo-anions or the elements that comprise them in raw or finished drinking waters. Accordingly, principles of the present disclosure contemplate a technical solution to overcome the challenges associated with temporal variability in concentrations of these oxo-anions by providing an average concentration based on continuous sampling and cumulative contaminant collection.

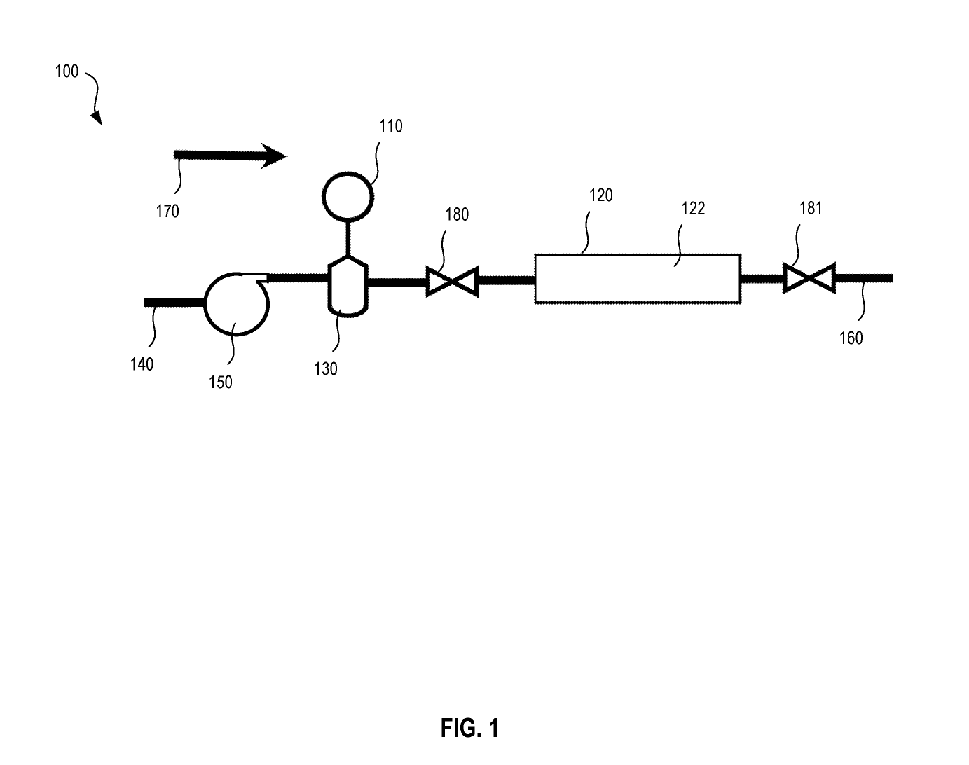

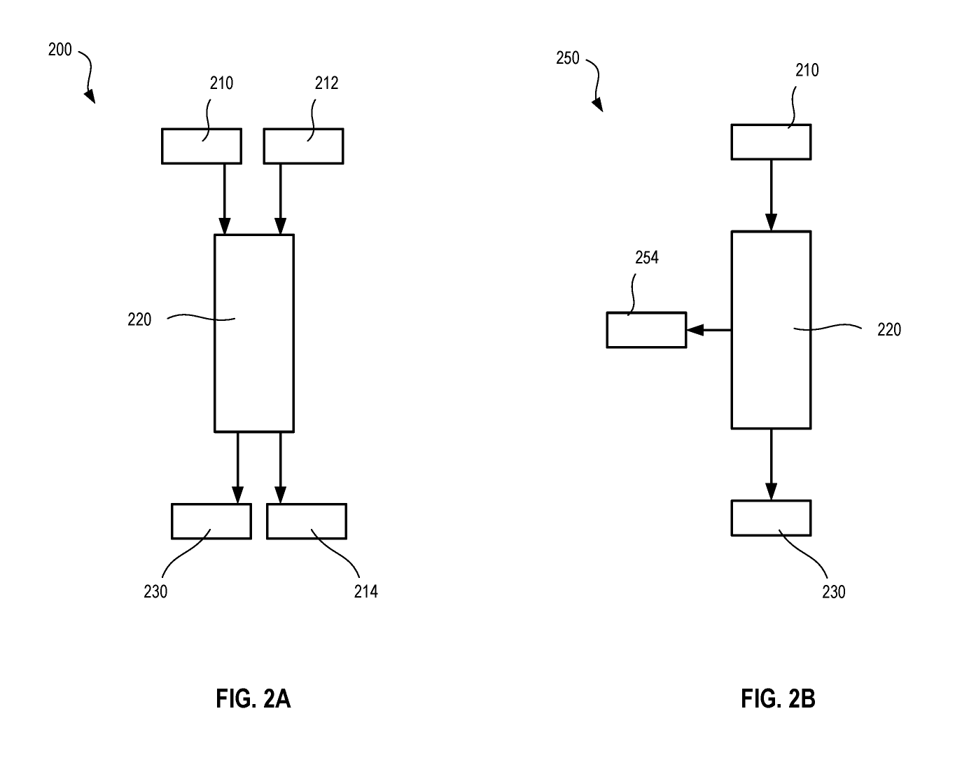

With reference now to FIGS. 1, 2A and 2B, principles of the present disclosure contemplate cumulative sampling systems and related methods for determining the presence and concentration of various contaminants in water systems, including hexavalent chromium, arsenic, and selenium, and the like. Exemplary cumulative sampling systems may be active (i.e., may be configured with pumps or other components for passing fluids over sorbent media) or passive (i.e., relying on diffusion transport to the sorbent media).

Exemplary cumulative sampler systems draw from the principle of operation of continuous flow sorbent. This is different from conventional water samplers, which are designed to automatically collect discrete water samples over a pre-programmed period. Unlike a conventional water sampler, which collects non-specific contaminant samples, exemplary cumulative sampler systems continuously collect a sample by concentrating and accumulating one or several specific contaminants onto a contaminant-selective media (typically ion exchange resin or sorbent) packed into a column.

The total accumulated mass of the contaminant can be determined via any suitable method, for example: (1) by eluting the contaminant from the media in a concentrated form and analyzing the elute concentration; or (2) by digesting the media using conventional acid digestion methods and analyzing the completely released contaminant. Mass balances of metal content from exemplary cumulative sampler systems may be compared with time-resolved samples from concurrently-deployed conventional sampling devices (for example, sampling devices provided by Teledyne ISCO of Lincoln, Nebr.); exemplary results indicate that continuous samplers provide a more accurate level of contaminant measurement.

By measuring the volume of water processed through a cumulative sampler system over the sampling period, an average concentration for the sampling period can be determined. This approach alleviates the probability of collecting samples that are representative of concentration extremes and could skew the data set, consequently providing information that does not reflect actual concentrations of contaminants in a water source. Further, this method allows for determining very low contaminant concentrations, which may not be detectable via conventional sampling and analysis methods.

In various exemplary embodiments and with reference now to FIG. 1, a cumulative sampler system 100 comprises a sampler cell 120. In various embodiments, sampler cell 120 may be removable from cumulative sampler system 100 such that it can be replaced periodically. Sampler cell 120 may be configured to receive water passing through cumulative sampler system 100 from a water source of interest. In various embodiments, the water source of interest may contain a contaminant sought to be detected and/or measured with cumulative sampler system 100. The water source of interest may be in fluid communication with an intake 140 of cumulative sampler system 100. In various embodiments, water may be communicated from the water source of interest through intake 140 and through sampler cell 120 prior to being discharged from discharge port 160. As represented by arrow 170, water flows through cumulative sampler system 100 in a direction from intake 140 to discharge port 160.

Sampler cell 120 may further be packed with a media 122 configured to adsorb a water contaminant as water passes through sampler cell 120. In various embodiments, sampler cell 120 may be configured as a column, though any suitable shape and/or configuration may be utilized. In various embodiments, media 122 comprises a strong base anion exchange (SBA) resin and/or weak base anion exchange (WBA) resin. In various embodiments, SBA resins may use quaternary amine functional groups functionalized with chloride to exchange Cr(VI) (for example, —X⁺—Cl⁻+HCrO₄⁻→—X⁺—HCrO₄⁻+Cl⁻), and/or WBA resins may use tertiary amines that can be loaded with hydroxide ions. In one embodiment, a WBA resin comprises epoxy polyamine configured with a 12×50 mesh size; however, any suitable WBA resin and mesh size may be utilized. In an embodiment, a SBA resin comprises styrene with a divinylbenzene (DVB) matrix in chloride form and configured with a 16×50 mesh size; however, any suitable SBA resin and mesh size may be utilized. In various embodiments, the WBA and/or the SBA resins may be ground and wet sieved to a sieve size #60-#80 with a mortar and pestle prior to being packed into a glass column. In various embodiments, the glass column is configured with an outer diameter of about 2.5 cm and an inner diameter of about 1.1 cm, maintaining a d_{column}/d_{particle} ratio>75/1 to minimize short-circuiting. In various embodiments, glass beads and/or glass wool may be placed in the column to distribute flow and contain the resin media. In various embodiments, media 122 may be selective for at least one of chromate, dichromate, or nitrate.

In various embodiments, cumulative sampler system 100 further comprises a cumulative flow meter 130 configured to measure the amount of water passing through cumulative sampler system 100. In various embodiments, cumulative flow meter 130 may comprise a metering pump and/or flow-totalizer meter. However, cumulative flow meter 130 may comprise any meter or other device suitable for measuring the rate, volume, and/or flow of water over time.

In various embodiments, cumulative sampler system 100 further comprises a pump 150 configured to draw water from the water source of interest through intake 140. Pump 150 may cause water to pass water through sampler cell 120. In various embodiments, pump 150 may comprise a positive displacement pump. However, any suitable pump may be utilized.

In various embodiments, cumulative sampler system 100 further comprises one or more valves. In various embodiments, a first valve 180 is disposed between cumulative flow meter 130 and sampler cell 120. In various embodiments, a second valve 181 is disposed between sampler cell 120 and discharge port 160. In various embodiments, first valve 180 and/or second valve 181 comprises a mechanical valve, such as a check valve or a ball valve, an electromechanical valve, such as a solenoid valve, and/or any type of valve suitable for use in cumulative sampler system 100.

In various embodiments and with reference now to FIGS. 2A and 2B, principles of the present disclosure contemplate methods 200, 250 of using a cumulative sampling system for measuring a water contaminant. In method 200, water 210 from a water source of interest and containing a water contaminant may be loaded onto sampler cell 220 containing anion exchange resins. In various embodiments, water 210 may be pumped at a flowrate of about 15 bed volumes per hour (+/−3 bed volumes per hour) (2 mL/min; 0.52 gpm/ft²), corresponding to about a 4 minute empty bed contact time (EBCT). Loading may be continuously applied until achieving a desired number of bed volumes. Communication of water 210 through sampler cell 220 may cause adsorption of the water contaminant to the anion exchange resins and discharge of a contaminant-depleted flow 230 from sampler cell 220.

In method 200, adsorbed oxo-anions may be removed from the resin of sampler cell 220 by any suitable means. In various embodiments, oxo-anion desorption may comprise passing an eluant 212 through sampler cell 220. In various embodiments, eluant 212 comprises 5% NaCl; however, any suitable eluant may be utilized. In various embodiments, eluant 212 is passed through sampler cell 220 at a flowrate of about 5 bed volumes per hour (0.26 mL/min) for 7.5 bed volumes total; however, any suitable flow rate and total volume may be utilized. In such embodiments, sampler cell 220 may comprise an SBA resin. In various embodiments, a medical grade pump may be used to meter the flow rate of eluant 212. In various embodiments, the recovered eluate 214 may be filtered and/or diluted. In various embodiments, filtering may be performed with a 0.45 μm cellulose membrane. In various embodiments, eluate 214 may be diluted about 50:1; other suitable dilution ratios may be utilized.

In method 250, after discharge of a contaminant-depleted flow 230, in various embodiments oxo-anion desorption may comprise removing a portion 254 of the resin from sampler cell 220 and subjecting portion 254 to microwave digestion. In various embodiments, digestion may occur in nitric acid and/or may follow SW 896 EPA Method 3052, Microwave Assisted Acid Digestion of Siliceous and Organically Based Matrices. In various embodiments, eluate 214 and/or the portion 254 of digested resin may be analyzed using ion chromatography and/or any other suitable method to determine a mass balance of contaminant adsorbed during communication of water 210 through sampler cell 220.

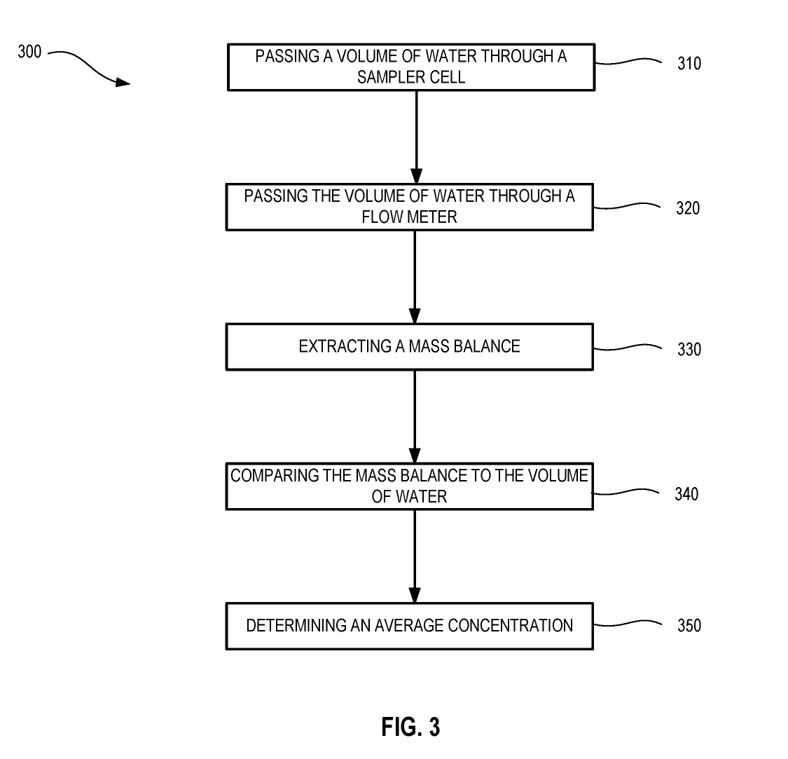

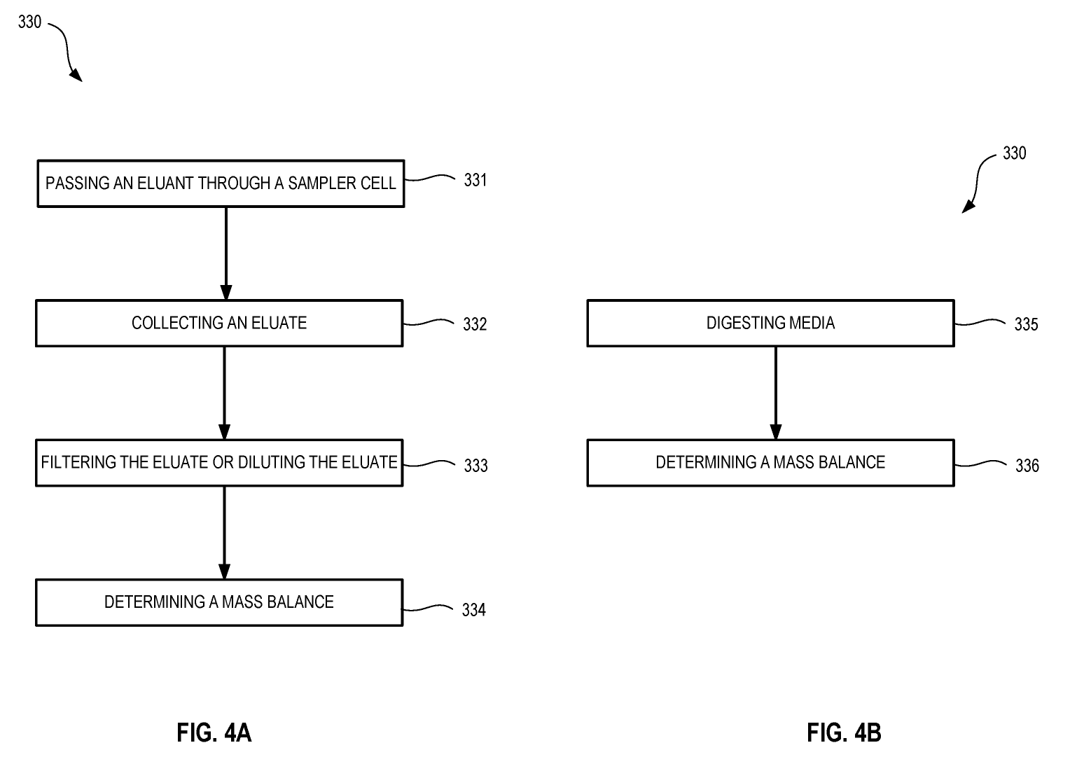

In various embodiments and with reference now to FIGS. 3, 4A, and 4B, a method 300 for measuring a water contaminant is disclosed. Method 300 comprises passing a volume of water through a sampler cell (step 310). The sampler cell is configured to adsorb the water contaminant. In various embodiments, method 300 further comprises passing the volume of water through a cumulative flow meter (step 320).

Method 300 further comprises extracting a mass balance of the water contaminant from the sampler cell (step 330). In various embodiments and with reference now to FIG. 4A, the extracting the mass balance (step 330) comprises passing an eluant through a sampler cell (step 331) and collecting an eluate (step 332). The eluant may be configured to desorb the water contaminant from the sampler cell. In various embodiments, the extracting the mass balance (step 330) further comprises at least one of filtering the eluate or diluting the eluate (step 333). In various embodiments, the extracting the mass balance (step 330) further comprises determining the mass balance of the water contaminant (step 334) through ion chromatography and/or any other suitable method.

With reference now to FIG. 4B, in some embodiments the extracting the mass balance (step 330) comprises digesting media of the sampler cell (step 335) and determining the mass balance of the water contaminant (step 336) through ion chromatography and/or any other suitable method.

With reference again to FIG. 3, method 300 may further comprise comparing the mass balance of the water contaminant to the volume of water passed through the sampler cell (step 340) and determining an average concentration of the water contaminant in the volume of water (step 350).

Via utilization of principles of the present disclosure, oxo-anion concentrations in water sources, including drinking water sources, may be measured with improved accuracy. Water sources contain oxo-anions, including carcinogens such as hexavalent chromium and arsenic, and measurement of oxo-anion concentrations is used for regulatory compliance and public health research. Conventional techniques for measurement, including time-resolved sampling, rely on collection of discreet samples at long intervals. Because oxo-anion concentrations are known to fluctuate significantly on a daily and/or seasonal basis, such time-resolved sampling techniques are less accurate than the disclosed systems and methods for continuous sampling and determination of average contaminant concentrations. Additionally, because the disclosed systems and methods are selective to particular contaminants and may continuously sample a water source for any desired length of time, contaminants which are present in concentrations too low for detection by conventional techniques can be detected and their concentrations can be accurately measured. Moreover, because the disclosed systems and methods continuously sample a water source, contaminants that occur sporadically can be detected and their concentrations can be accurately measured.

Although the exemplary embodiments disclosed herein discuss hexavalent chromium and similar oxo-anions, it will be appreciated that media substitution and modification allows for sampling of contaminants with chemistries that are different from the example oxo-anion. Thus, principles of the present disclosure may be applicable to a wide range of water contaminants.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. When language similar to “at least one of A, B, or C” or “at least one of A, B, and C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A cumulative sampler system for measuring a water contaminant, the cumulative sampler system comprising:
an intake configured to be in fluid communication with a water source of interest;
a cumulative flow meter configured to measure a volume of water passing through the cumulative sampler system; and
a sampler cell configured to receive water from the intake, the sampler cell comprising a media configured to adsorb the water contaminant.

2. The cumulative sampler system of claim 1, further comprising:
a pump coupled to the intake, the pump configured to draw water from the water source of interest through the intake.

3. The cumulative sampler system of claim 2, further comprising:
a first valve disposed between the cumulative flow meter and the sampler cell; and
a second valve disposed between the sampler cell and a discharge port of the cumulative sampler system.

4. The cumulative sampler system of claim 3, wherein the sampler cell is removable from the cumulative sampler system.

5. The cumulative sampler system of claim 2, wherein the media comprises at least one of a strong base anion exchange resin or a weak base anion exchange resin.

6. The cumulative sampler system of claim 2, wherein the water contaminant comprises at least one of hexavalent chromium, arsenic, or selenium.

7. A method for measuring a water contaminant, the method comprising:
passing, through a sampler cell configured to adsorb the water contaminant, a volume of water containing the water contaminant;
extracting, from the sampler cell, a mass balance of the water contaminant;
comparing the mass balance to the volume of water; and
determining an average concentration of the water contaminant.

8. The method of claim 7, further comprising:
passing, though a cumulative flow meter, the volume of water.

9. The method of claim 7, wherein the passing through the sampler cell comprises a flowrate of about 15 bed volumes per hour.

10. The method of claim 7, wherein the water contaminant comprises at least one of hexavalent chromium, arsenic, or selenium.

11. The method of claim 8, wherein the extracting comprises:
passing, through the sampler cell, an eluant configured to desorb the water contaminant;
collecting an eluate containing the water contaminant; and
determining the mass balance of the water contaminant.

12. The method of claim 11, wherein the extracting further comprises at least one of filtering the eluate or diluting the eluate.

13. The method of claim 8, wherein the sampler cell comprises a media and the extracting comprises:
digesting the media; and
determining the mass balance of the water contaminant.

14. A method for measuring a water contaminant, the method comprising:
passing, through a cumulative sampler system, a volume of water, wherein the cumulative sampler system comprises:
a pump coupled to an intake, the pump configured to draw the volume of water from a water source of interest through the intake;
a cumulative flow meter configured to measure the volume of water passing through the cumulative sampler system; and
a sampler cell configured to receive the volume of water from the pump;
extracting, from the sampler cell, a mass balance of the water contaminant;
comparing the mass balance to the volume of water; and
determining an average concentration of the water contaminant.

15. The method of claim 14, wherein the water contaminant comprises at least one of hexavalent chromium, arsenic, or selenium.

16. The method of claim 14, wherein the sampler cell comprises a media configured to adsorb the water contaminant.

17. The method of claim 16, further comprising:
passing, though the cumulative flow meter, the volume of water.

18. The method of claim 17, wherein the extracting comprises:
passing, through the sampler cell, an eluant configured to desorb the water contaminant;
collecting an eluate containing the water contaminant; and
determining the mass balance of the water contaminant.

19. The method of claim 18, wherein the extracting further comprises at least one of filtering the eluate or diluting the eluate.

20. The method of claim 17, wherein the extracting comprises:
digesting the media; and
determining the mass balance of the water contaminant.
